(19) United States
(12) Patent Application Publication
(10) Pub. No.: US 2010/0314366 A1
(43) Pub. Date: Dec. 16, 2010

(54) APPARATUS AND METHOD FOR ARRANGING THROUGH OPENINGS IN A MOVABLE BAND

(75) Inventor: Sigmund Niklas, Zell (DE)

Correspondence Address: BLACK LOWE & GRAHAM, PLLC, 701 FIFTH AVENUE, SUITE 4800, SEATTLE, WA, 98104, US

(73) Assignee: Muhlbauer AG, Roding (DE)

(21) Appl. No.: 12/446,502

(22) PCT Filed: Oct. 22, 2007
(86) PCT No.: PCT/EP07/61293

§ 371 Date: Apr. 21, 2009

(30) Foreign Application Priority Data
Oct. 21, 2006 (DE) 20 2006 016 155.4
Oct. 19, 2007 (DE) 10 2007 050 501.0

(51) Int. Cl. B23K 26/38

(52) U.S. Cl. 219/121.71; 219/121.7

(57) ABSTRACT

An apparatus and a method for arranging through-openings in a flexible, movable band, said through-openings being arranged in series in at least one row, wherein each through-opening is arranged in the bottom of one of a plurality of depressions for receiving electronic components, said depressions being arranged in series in at least one row, wherein a laser device with at least one laser beam is arranged so as to act on sides of bottoms of the depressions facing away from the depressions, wherein the laser device is designed in such a way that, by means of the at least one laser beam, the through-openings can be burned into a predefinable portion of the band at predefinable positions on the bottom sides, within a predefinable period of time.

The invention relates to an apparatus and a method for arranging through-openings in a flexible, movable band, said through-openings being arranged in series in at least one row, wherein each through-opening is arranged in the bottom of one of a plurality of depressions for receiving electronic components, said depressions being arranged in series in at least one row, according to the preambles of claims 1 and 16.

Blister tapes are often used to pack, for further transport, extremely small components into pockets arranged in said blister tape and designed as depressions. To this end, vacuum channels in the form of extremely small through-bores of small diameter, namely for example of 0.4 mm, are required on the underside, i.e. on the bottom of the depressions, in order to achieve a fixing of the component in the pocket by means of an applied vacuum.

Such through-openings have until now been cut out or punched out mechanically by means of a cutting punch, wherein this mechanical cutting process, due to the necessary minimum dimensions of a cutting punch, could be used only within limits for holes or through-openings of not less than 0.4 mm.

In one possible design of the cutting punch with an even smaller diameter, the formation of burrs and raised areas in the region of the punched edges occur, which prevent extremely small components, such as dies for example, from being oriented as desired and thus do not ensure that the components can be reliably picked up out of these pockets again.

Accordingly, the object of the invention is to provide an apparatus and a method for arranging through-openings in a flexible, movable band, said through-openings being arranged in series in at least one row, which makes it possible to arrange through-openings, without any burrs in the edge regions thereof, in depressions of the band in a quick and easy manner.

This object is achieved in terms of the apparatus by the features of claim 1 and in terms of the method by the features of claim 16.

One essential aspect of the invention lies in the fact that, in an apparatus for arranging through-openings in a flexible, movable band, said through-openings being arranged in series in at least one row, and said band having depressions arranged in series for receiving electronic components, in the bottom of which depressions the through-openings are arranged, a laser device with at least one laser beam is arranged so as to act on sides of bottoms of the depressions facing away from the depressions. The laser device is designed in such a way that, by means of the at least one laser beam, the through-openings can be burned into a predefinable portion of the band at predefinable positions on the bottom sides, within a predefinable period of time. This makes it possible to arrange, quickly and easily and largely without burrs, a plurality of through-holes which are in each case arranged in one of the depressions of the band, wherein, due to the use of a laser, even through-openings with a very small diameter, i.e. for example less than 0.3 mm, are possible.

According to one preferred embodiment, the through-openings are of circular shape with a diameter of less than 0.3 mm, preferably of 0.1-0.15 mm.

The method according to the invention advantageously makes it possible to use, simultaneously or in succession, one or a plurality of laser beams to arrange the through-openings in the band, said through-openings being arranged in series, wherein advantageously a band portion is defined into which these through-openings are burned without burrs from below or—if the band is arranged upside down—from above, effectively and at a high speed.

The portion of the band preferably comprises 2-10 depressions, preferably 4-8 depressions. During a brief stoppage of this portion, this portion is simultaneously provided with the through-openings by the laser device by using a plurality of laser beams.

Preferably, the predefinable period of time lies in a range from 50-300 ms, preferably 120 ms, thereby resulting in a very quick production of the through-openings and thus a high throughput of the entire device for arranging through-openings.

Of course, if a plurality of laser beams are used simultaneously, the throughput of the device as a whole can be significantly increased when using the method according to the invention, attention being paid to the fact that, due to the angled position of the individual laser beams, particularly the first and last laser beam emitted in a row, an additional angle calculation in relation to the emission angle of these laser beams is required in order to obtain a suitable through-opening on the inside of the bottom region, i.e. facing towards the depression. This must be calculated beforehand, optionally by means of a calculation unit, in order to take account of the deviations in the through-opening diameters which are obtained as a result of this angled emission of the laser beams and are due to the finite layer thickness of the bottom material.

According to one further development of the invention, a device is provided for briefly stopping the portion of this band in such a way that the bottoms of the depressions of the portion which are to be processed are simultaneously at the shortest possible distance from the laser device as a function of the running plane of the band. This makes it possible for the through-openings formed by the laser device always to be formed in that portion which is momentarily located closest to the laser device. Ideally, the middle through-opening in a row will be arranged directly below the laser device, whereas the first and last through-openings will be at the same distance from the laser device. Alternatively, a laser device may be used which has a laser beam that moves continuously with and at the same speed as the band movement, so that the through-opening can be burned in while the band is moving. This avoids any differences in diameter of the through-openings brought about as a result of the angled emission of the laser beams.

A control device for controlling a simultaneous or successive directing of the laser beam(s) onto the predefined positions of preferably 4 or 8 depression bottom sides of the portion serves to carry out the fastest possible simultaneous processing of the bottoms of the depressions, i.e. of the pockets, with regard to the through-openings.

The depressions are preferably of square shape with an edge length of 0.1-1.0 mm, preferably of 0.35 mm, with the positions of the through-openings arranged in the centre of the square bottom surfaces.

Of course, other basic shapes are also possible for the depressions and also for the through-openings to be formed, in order thus to obtain an ideal adaptation to the respective component to be fixed.

As the laser, preferably a CO₂ laser is used in the laser device. As an alternative or in addition, a laser beam of the laser device may be applied as a fibre laser.

The lasers preferably have a wavelength of 10 600 nm or 1090 nm.

According to one preferred further development of the invention, a laser of the laser device is preferably arranged such that it can be displaced relative to the running plane of the band, so as not to obtain a laser beam impinging at an angle on the bottom surfaces, but rather to obtain a perpendicular impingement of the laser beam relative to the running plane of the band. This allows an even more precise formation of the through-openings with regard to the diameter.

The laser device may comprise a plurality of lasers which are assigned to individual sub-portions of the portion, in order to ensure an even quicker processing of the band and of the bottom surfaces of the depressions arranged therein.

The band is preferably made from a material with a carbon content that is constant over its surface, since this leads to satisfactory edge formations of the through-openings with regard to the undesired formation of burrs.

According to one preferred embodiment, after each laser operation the depressions are cleaned from below by means of compressed air, i.e. by generating an overpressure. Of course, any other type of cleaning process is conceivable. A cleaning by adding carbon dioxide snow is also conceivable, in order to free the depressions or cavities from any dirt produced by the laser operation.

Preferably, the depressions or cavities are processed simultaneously by the lasers.

Further advantageous embodiments can be found in the dependent claims.

Advantages and expedient features will emerge from the following description in conjunction with the drawing. In the drawing:

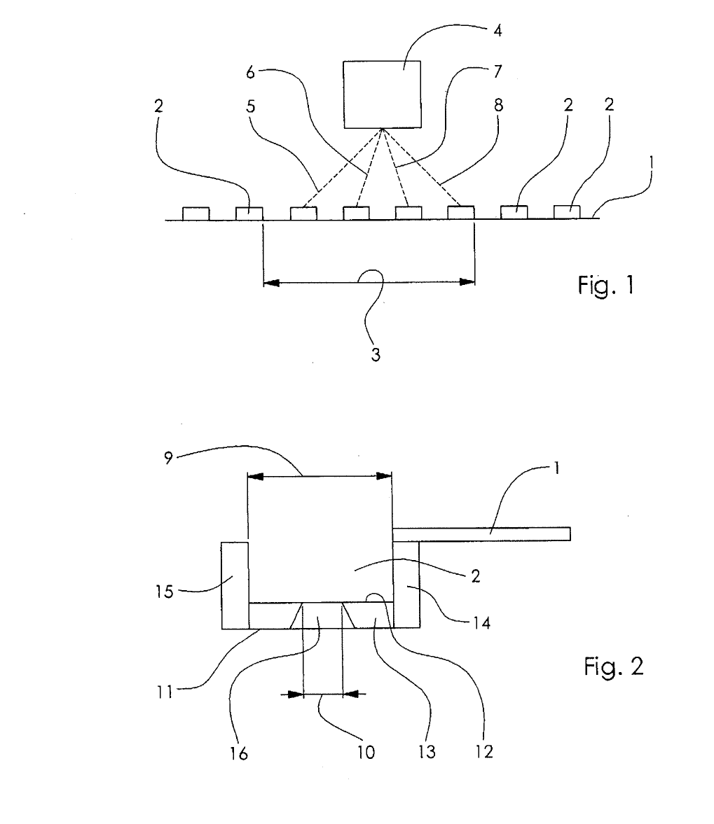

FIG. 1 shows, in a schematic view, the basic structure of the apparatus according to the invention;

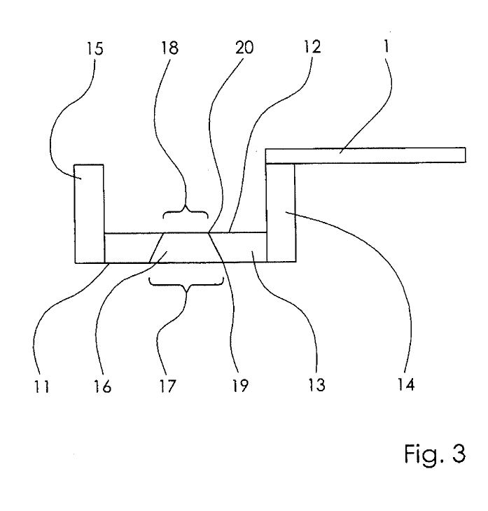

FIG. 2 shows, in a cross-sectional view of a detail on an enlarged scale, a pocket of a blister tape band with a through-opening arranged according to the invention, and

FIG. 3 shows, in a cross-sectional view of a detail on an enlarged scale, the pocket of the blister tape band.

FIG. 1 shows, in a schematic view, the possible structure of the apparatus according to the invention for arranging through-bores or through-holes in a blister tape or blister tape band 1. The band is placed upside down so that depressions 2, which are designed in the manner of pockets, point upwards, i.e. the openings thereof are directed downwards.

In a predefined portion 3 of the band 1, either four or eight depressions are arranged which are at a distance of 4 mm or 2 mm from one another and are arranged in series on the band.

The portion 3 is moved as a whole along a distance of 16 mm by means of an advance movement device, and comes to a stop below a laser device 4.

The laser device 4 comprises a laser, which may be designed as a CO₂ laser and/or fibre laser.

The laser device 4 emits a total of 4 laser beams 5, 6, 7 and 8 simultaneously or in succession onto an underside of bottoms of the depressions over a time period of 120 ms, in order to arrange through-holes therein by means of a burning process, said through-holes having a diameter of for example 0.15 mm.

The tape is preferably made from a material which has a carbon content that is constant over the surface with very little carbon fluctuations. The short processing times are advantageously achieved as a result, since a plurality of through-holes can be processed simultaneously with the same processing times.

As the material, advantageously polycarbonate is used for the band, since this assists the hole burning process. Polystyrene, on the other hand, is not suitable for this.

FIG. 2 shows, in a schematic cross-sectional view of a detail on an enlarged scale, a pocket 2 as arranged in a tape/band 1. The pocket 2 has a diameter 9 of for example 0.35 mm and is of circular shape. As an alternative, the pocket may have a base surface of square shape with an edge length of 0.35 mm.

On the inner upper side 12 of the bottom 13 of the depression 2, which has side walls 14 and 15, the through-opening 16 that has been formed by the laser beam is arranged with a diameter 10 which may be for example 0.15 mm. On an underside of the bottom surface 13, on the other hand, the through-opening 16 has a larger diameter.

FIG. 3 also shows, in a cross-sectional view and in detail, a pocket or depression. The pocket 2 once again comprises the side walls 14, 15 and the bottom surface 13, in which the through-opening 16 is arranged. Due to the laser emission, the through-opening preferably has a diameter 18 on the upper side and a larger diameter 17 on the underside.

In edge regions 19 on the underside 11 of the bottom surface 13, only very small raised edges are permitted as a result of the laser burning process. A maximum raised height of 0.1 mm relative to the plane of the underside 11 of the bottom surface 13 is acceptable, so as to avoid any hindrance during the subsequent band handling and vacuum application operations.

On the inner side or upper side 12 of the bottom surface 13, on the other hand, if possible there should be no raised areas in the region of the edge 20 of the bottom surface inner side 12.

A temperature setting of the laser burning process by selecting the laser material, the material of the tape or of the bottom surface and the laser intensity should be set in such a way that no bottom deformation of the bottom surface 13 takes place as a result.

Preferred wavelengths of the lasers used are 10,600 nm for a CO₂ laser and 1090 nm in the case of a fibre laser.

By using such extremely small vacuum bores in depressions within blister tapes, a broader use of these blister tapes for die sorters is possible.

All of the features disclosed in the application documents are claimed as essential to the invention in so far as they are novel individually or in combination with respect to the prior art.

### LIST OF REFERENCES

1 blister band

2 depressions

3 portion

4 laser device

5, 6, 7, 8 laser beam

9 size of the depression

10 size of the through-hole

11 underside of the bottom surface

12 upper side of the bottom surface

13 bottom surface

14, 15 side walls

16 through-opening

17 bottom diameter of the through-opening

18 top diameter of the through-opening

19, 20 edge regions

1. An apparatus for arranging through-openings in a flexible, movable band, said through-openings being arranged in series in at least one row, wherein each through-opening is arranged in the bottom of one of a plurality of depressions for receiving electronic components, said depressions being arranged in series in at least one row along and perpendicular to the band, comprising a laser device with having at least one laser beam configured to act on sides of bottoms of the depressions facing away from the depressions to burn through-openings into a predefinable portion of the band at predefinable positions on the bottom sides, within a predefinable period of time.

2. The apparatus according to claim 1, wherein the through-openings are of circular shape with a diameter of less than 0.3 mm.

3. The apparatus according to claim 1 wherein the portion of the band comprises less than ten depressions.

4. The apparatus according to claim 1, wherein the predefinable period of time lies in a range between approximately 50 ms and approximately 300 ms.

5. The apparatus according to claim 1, further comprising an alignment device for briefly stopping the portion of the band in such a way that the bottoms of the depressions of the portion which are to be processed are at the shortest possible distance from the laser device as a function of the running plane of the band.

6. The apparatus according to claim 1, further comprising a control device for controlling a simultaneous or successive directing of the laser beam onto the predefined positions of depression bottom sides of the portion.

7. The apparatus according to claim 1, wherein the through-openings are conical in cross section.

8. The apparatus according to claim 1, wherein the depressions are of square shape with an edge length of between approximately 0.1 mm and approximately 1.0 mm.

9. The apparatus according to claim 1, wherein a CO₂ laser is used as the laser of the laser device.

10. The apparatus according to claim 1, wherein a fibre laser is used as the laser of the laser device.

11. The apparatus according to claim 1, wherein the laser beam of the laser device is guided in a fibre to the positions.

12. The apparatus according to claim 9, wherein the laser has a wavelength of 10,600 nm or 1090 nm.

13. The apparatus according to claim 1, wherein the laser of the laser device is configured parallel to the running plane of the band.

14. The apparatus according to claim 1, wherein the laser device comprises a plurality of lasers which are assigned to individual sub-portions of the portion.

15. The apparatus according to claim 1, wherein the band is made from a material with a carbon content that is constant over its surface.

16. A method for arranging through-openings in a flexible, movable band having a plurality of depressions for receiving electronic components, comprising:
aligning a laser device having at least one laser beam with a predefinable position on the bottom side of at least one of the depressions; and
burning a through-opening into a predefinable portion of the band at a predefinable positions on the bottom sides, of the at least one depression within a predefinable period of time.

17. The method according to claim 16, wherein aligning the laser device comprising aligning a plurality of laser beams simultaneously with a predefinable position on the bottom side of a plurality of depressions.

18. The method according to claim 16, wherein the through-openings are of circular shape with a diameter of less than 0.3 mm, preferably of 0.1-0.15 mm.

19. The method according to claim 16, wherein the portion of the band comprises less than ten depressions.

20. The method according to claim 16, wherein the at least one laser beam burns the through-openings within the predefinable period of time in a range between approximately 50 ms and approximately 300 ms.

21. The method according to claim 17, further comprising halting the portion of the band in such a way that the bottoms of the depressions of the portion which are to be processed are simultaneously at the shortest possible distances from the laser device as a function of the running plane of the band.

22. The method according to claim 16, wherein aligning a laser device having at least one laser beam with a predefinable position on the bottom side of at least one of the depressions further comprises a simultaneously or successively directing the laser beam onto the predefined positions of depression bottom sides of the portion using a control device.

23. The apparatus according to claim 2, wherein the through-openings are of circular shape with a diameter between approximately 0.1 mm and approximately 0.15 mm.

24. The apparatus according to claim 3, wherein the portion of the band comprises four depressions.

25. The apparatus according to claim 3, wherein the portion of the band comprises eight depressions.

26. The apparatus according to claim 4, wherein the predefinable period of time is approximately 120 ms.

27. The apparatus according to claim 8, wherein the depressions are of square shape with an edge length of approximately 0.35 mm.

28. The apparatus according to claim 1, wherein the depressions are of square shape with the position of a through-opening arranged in the centre of the square bottom surface.

29. The apparatus according to claim 10, wherein the laser has a wavelength of 10,600 nm or 1090 nm.

30. The method according to claim 16, further comprising positioning a series of the plurality of depressions in at least one row along a running plane of the band.

31. The method according to claim 18, wherein the through-openings are of circular shape with a diameter between approximately 0.1 mm and approximately 0.15 mm.

32. The method according to claim 19, wherein the portion of the band comprises four depressions.

33. The method according to claim 19, wherein the portion of the band comprises eight depressions.

34. The method according to claim 20, wherein the wherein the predefinable period of time is approximately 120 ms.
